(19) United States
(12) Patent Application Publication
(10) Pub. No.: US 2023/0071046 A1
(43) Pub. Date: Mar. 9, 2023

(54) ACTIVE LEARNING OF DATA MODELS FOR SCALED OPTIMIZATION

(71) Applicants: International Business Machines Corporation, Armonk, NY (US); MIT MASSACHUSETTS INSTITUTE OF TECHNOLOGY, Cambridge, MA (US)

(72) Inventors: Raphaël Pestourie, Cambridge, MA (US); Youssef Mroueh, New York, NY (US); Payel Das, Yorktown Heights, NY (US); Steven Glenn Johnson, Arlington, MA (US)

(21) Appl. No.: 17/405,318

(22) Filed: Aug. 18, 2021

(51) Int. Cl. G06N 20/00; G06N 5/04

(52) U.S. Cl. CPC G06N 20/00; G06N 5/04

(57) ABSTRACT

Embodiments of the present invention provide computer-implemented methods, computer program products and computer systems. Embodiments of the present invention can, in response to receiving parameters associated with a problem, train at least one generated data model to evaluate an estimation of a solution for the problem. Embodiments of the present invention can then generate an uncertainty quantification measure associated with an estimation of error for the at least one generated data model. Embodiments of the present invention can then filter data based on the generated uncertainty quantification measure associated with the at least one generated data model and automatically retrain the at least one generated data model using the remaining data from the filtered data

### STATEMENT REGARDING FEDERALLY SPONSORED RESEARCH OR DEVELOPMENT

This invention was made with government support under HR0011-20-9-0016 awarded by Defense Advanced Research Projects Agency (DOD/DARPA), and W911NF-13-D-0001 and W911NF-18-2-0048 awarded by U.S. Army Research Office (ARO). The government has certain rights in the invention.

### STATEMENT REGARDING PRIOR DISCLOSURES BY THE INVENTOR OR A JOINT INVENTOR

The following disclosure(s) are submitted under 35 U.S.C. § 102(b)(1)(A):

### DISCLOSURE(S)

(1) Raphaël Pestourie, Youssef Mroueh, Thanh V. Nguyen, Payel Das, Steven G. Johnson, “Active Learning of Deep Surrogates for PDEs: Application to metasurface Design”, submitted on arXiv, Aug. 24, 2020, https://arxiv.org/abs/2008.12649.
(2) Raphaël Pestourie, Youssef Mroueh, Thanh V. Nguyen, Payel Das, Steven G. Johnson, “Active Learning of Deep Surrogates for PDEs: Application to metasurface Design”, NPJ Computational materials, Oct. 29, 2020, https://doi.org/10.1038/s41524-020-00431-2.

### BACKGROUND

The present invention relates generally to the field of data modeling technology, and more specifically to increasing efficiency of trained data models for large scale optimization.

Data modeling typically refers to the process of generating a data model. A data model generally refers to an abstract model that organizes elements of data and can standardize how it relates to one another and to the properties of real-world entities. In some instances, a data model can refer to an abstract formalization of the objects and relationships found in a particular application domain. In other instances, a data model can refer to a set of concepts used in defining formalizations for concepts. Data models can be used to explicitly determine the structure of data. Data models are typically specified by a data specialist, data librarian, or a digital humanities scholar in a data modeling notation. These notations are often represented in graphical form.

### SUMMARY

Embodiments of the present invention provide a computer system, a computer program product, and a method that comprises: in response to receiving parameters associated with a problem, training at least one generated data model to evaluate an estimation of a solution for the problem; generating an uncertainty quantification measure associated with an estimation of error for the at least one generated data model; filtering data based on the generated uncertainty quantification measure associated with the at least one generated data model; and automatically retraining the at least one generated data model using the remaining data from the filtered data.

### BRIEF DESCRIPTION OF THE DRAWINGS

Preferred embodiments of the present invention will now be described, by way of example only, with reference to the following drawings, in which:

FIG. 1 is a functional block diagram depicting an environment with a computing device connected to or in communication with another computing device, in accordance with at least one embodiment of the present invention;

FIG. 2 is a flowchart illustrating operational steps for evaluating a generated data model based on dynamically selected data points using a partial differential equation algorithm, in accordance with at least one embodiment of the present invention;

FIGS. 3A and 3B are a set of exemplary graphs displaying a plurality of results associated with dynamically selecting at least one data point within the generated data model, in accordance with at least one embodiment of the present invention; and

FIG. 4 depicts a block diagram of components of computing systems within a computing display environment of FIG. 1, in accordance with an embodiment of the present invention.

### DETAILED DESCRIPTION

Embodiments of the present invention recognize partial differential equations (PDEs) are used for large scale optimization. Specifically, embodiments of the present invention recognize that surrogate models for PDEs are trained models that evaluate the solution for PDEs orders of magnitude faster than solving for the PDEs directly. Surrogate models are used thousands to millions of times for large scale simulation and optimization of complex structures. Embodiments of the present invention recognize applications of this method encompass Maxwell's equations, Boltzmann transport equation, mechanics, quantum physics, and fluidics. Embodiments of the present invention provide solutions for improving training of surrogate models by finding the smallest (e.g., least amount) set of training points (acquired via expensive simulations/black-box function) that will best increase the accuracy of a trained surrogate model for PDE based on training feedback.

Embodiments of the present invention recognizes challenges in providing this solution (e.g., finding the smallest set of training points that best increases the accuracy of a trained surrogate model for PDE based on training feedback) include dimensionality and exploration-exploitation tradeoffs. Specifically, embodiments of the present invention recognize that when the input of the surrogate model is highly dimensional, the number of training points needed to train the model increase exponentially for traditional surrogate techniques and is very big for neural network surrogates. With respect to exploration-exploitation trade-offs, embodiments of the present invention recognize that numerical solves-that generate data are expensive.

As such embodiments of the present invention seek to leverage existing training data to inform where to explore next. Specifically, embodiments of the present invention provide solutions for training surrogate models for expensive PDE queries or black-box function. Embodiments of the present invention also provide a filtering technique based on an uncertainty measure to find the best training points to explore. Specifically, embodiments of the present invention provide an active learning algorithm that trains these models. This active learning algorithm can be used to perform “on the fly” calculations (e.g., dynamic calculations where expensive PDE queries are made inside the loop) and offline calculations (e.g., where the algorithm is reusing precomputed data). In this manner, as described in greater detail, later in this Specification, embodiments of the present invention can thus generate a trained surrogate model that needs at least an order of magnitude less training points compared to random sampling to reach a given accuracy and can evaluate the solution the PDE at least two orders of magnitude faster than solving for the PDE directly.

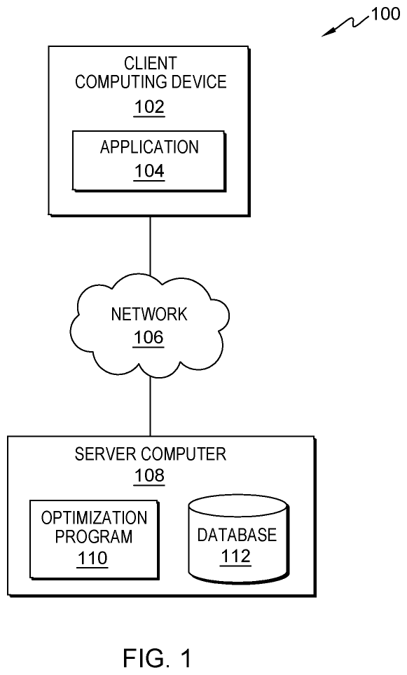

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

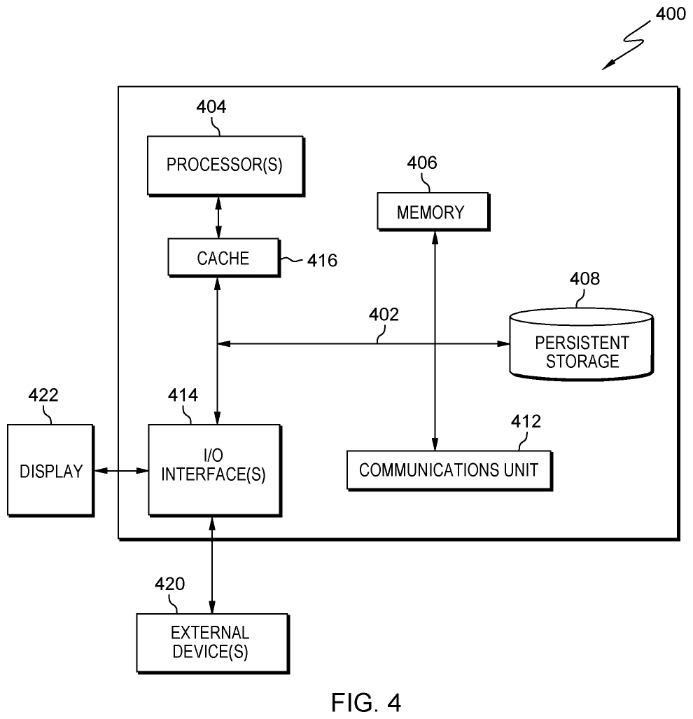

Computing environment 100 includes client computing device 102 and server computer 108, all interconnected over network 106. Client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computer as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 4.

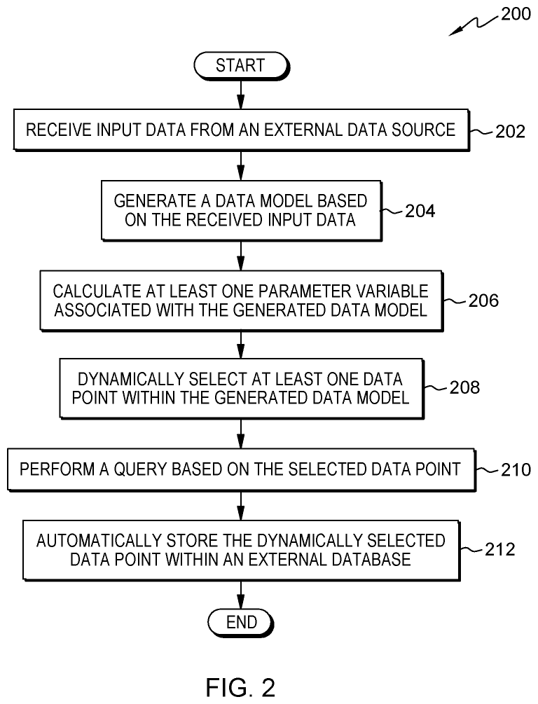

In this embodiment, client computing device 102 is a user device associated with a user and includes application 104. Application 104 communicates with server computer 108 to access optimization program 110 (e.g., using TCP/IP) to access content, user information, and database information. Application 104 can further communicate with optimization program 110 to train surrogate models for expensive PDE queries or black-box function and to provide a filtering technique based on an uncertainty measure to find the best training points to explore, as discussed in greater detail in FIGS. 2-4.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts optimization program 110 and database 112. In this embodiment, optimization program 110 resides on server computer 108. In other embodiments, optimization program 110 can have an instance of the program (not shown) stored locally on client computer device 102. In other embodiments, optimization program 110 can be a standalone program or system that trains surrogate models and provides filtering techniques to find the best training points to explore. In yet other embodiments, optimization program 110 can be stored on any number or computing devices.

Optimization program 110 trains surrogate models in a more efficient manner for expensive PDE queries or black-box functions and provides filtering techniques based on an uncertainty measure to find best training points to explore. For example, in some embodiments, optimization program 110 can leverage uncertainty quantification for active learning of optimization sub-problems. Specifically, in some embodiments, optimization program 110 can estimate uncertainty by using linear or non-linear machine learning models for solving optimization problems with different types of input (e.g., for parameterized input: fully connected architecture for image input, convolutional architecture for sequential input, e.g., recurrent architecture). In this embodiment, optimization program 110 utilizes two components of a model (which can be performed by the same model or by two different models. For example, a first component of optimization program 110 is a surrogate model (not shown) which predicts the PDE solution. A second component of optimization program 110 is an uncertainty estimate. In some embodiments, optimization program 110 could function in a neural network ensemble and can also extent to a meta-learning, Gaussian process, Monte Carlo dropout, entropy estimate, random forests, linear regression or other forms of uncertainty quantification.

In this manner, optimization program 110 can increase efficiency of expensive large-scale optimizers (e.g., a partial differential equation solver). This can be used to generate efficient metamaterial design and may also include molecule optimization and process optimization. In this embodiment, optimization program 110 can optimally use partial differential equations solver (E.g., Maxwell's equations, thermal transfer—Boltzmann transport equation, mechanics, quantum physics, fluidics, etc. In some embodiments, optimization program 110 can leverage online exploration-exploitation to increase efficiency.

For example, optimization program 110 can receive a request to generate an optimal optical meta-surface design. In this example, meta-surfaces are optical devices that are aperiodically patterned at the nanoscale. Each pattern is a degree of freedom to be optimized, therefore meta-surface design is a large-scale optimization problem. Each pattern can be simulated independently using decomposition methods, therefore surrogate models can solve for the PDE at the pattern level (which will be reused many times for the simulation of a single meta-surface).

In this embodiment, optimization program 110 begins with received parameters, expressed as “p”. Optimization program 110 fits t(p) to a surrogate model to evaluate an estimation of the solution to a PDE quickly expressed by Formula 1:

\tilde{t}(p)≈t(p) 1)

In this embodiment, optimization program 110 defines an uncertainty quantification (UQ) measure which is an estimate of r(p), the true error of the model expressed by Formula 2:

\tilde{r}(p)≈r(p) 2)

The surrogate model for each of the real and imaginary parts of the complex transmission is an ensemble of J=5 independent neural networks (NNs) with the same training data but different random batches on each training step. Each of NN i is trained to output a prediction μi(p) and an error estimate σi(p) for every set of parameters p. To obtain these μi and σi from training data y(p) (from brute-force offline Maxwell solves) optimization program 110 utilizes Formula 3 reproduced below:

$$- {\sum }_{p} log {p}_{{Θ}_{i}} ( y \vert p ) = {\sum }_{p} [ log {σ}_{i} ( p ) + \frac{{( y ( p ) - {μ}_{i} ( p ) )}^{2}}{2 {{σ}_{i} ( p )}^{2}} ] \qquad 3 )$$

over the parameters Θi of NN i.

Optimization program 110 can then generate the final prediction, μ*, (for the real or imaginary part of t(p)) and its associated error estimate σ* are combined as Formula 4 and 5 respectively:

$$\tilde{t} ( p ) = {μ}_{*} ( p ) = \frac{1}{J} {\sum }_{i = 1}^{J} {μ}_{i} ( p ) \qquad 4 )$$

$$\tilde{\tilde{r}} ( p ) = {σ}_{*}^{2} ( p ) = \frac{1}{J} {\sum }_{i = 1}^{J} ( {σ}_{i}^{2} ( p ) + {μ}_{i}^{2} ( p ) ) - {μ}_{*}^{2} ( p ) . \qquad 5 )$$

In this embodiment, optimization program 110 can express the estimation from a neural network trained with a Mean Squared Error (MSE) loss function expressed as Formula 6:

\tilde{t}(p)=NN(p) 6)

In this embodiment the UQ measure is from a meta-learner, which can learn the true mean square error between the estimation model and the evaluated expensive queries.

Expressed another way, optimization program 110 can generate the following algorithm,

Algorithm 1: Active-learning of the surrogate model

Result: \tilde{t}(p) (u_{*} and σ_{*})
P₀ = nᵢₙᵢₜ points chosen at random
Solve expensive PDE for each points in P₀
Create the first iteration of the labeled training set TS₀
Train the ensemble \tilde{t}⁰ (p) on TS₀
for i = 1:T do

Rᵢ = M × K points chosen at random;
Compute (cheaply) the error measures σ_{*}ⁱ⁻¹(p) using \tilde{t}ⁱ⁻¹ , ∀ p ∈ Rᵢ;
Pᵢ = select K points in Rᵢ with the highest error measures σ_{*}ⁱ⁻¹;
Solve expensive PDE for each points in Pᵢ and get t(p), ∀ p Pᵢ ;
Augment the labeled training set with the ne labeled data TSᵢ;
Train the ensemble \tilde{t}ⁱ(p) on TSᵢ;

end

Database 112 stores received information and can be representative of one or more databases that give permissioned access to optimization program 110 or publicly available databases. For example, database 112 can store received or generated training data. In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

FIG. 2 is a flowchart 200 depicting for evaluating a generated data model based on dynamically selected data points using a partial differential equation algorithm, in accordance with at least one embodiment of the present invention.

In step 202, optimization program 110 receives input. In this embodiment, input can refer to a request to solve a problem (e.g., an optimization of a complex problem) and can include one or more training data sets. In this embodiment, optimization program 110 receives input data from server computer device 108 via a network 106. In other embodiments optimization program 110 can receive input from one or more other components of computing environment 100.

In step 204, optimization program 110 trains at least one generated data model based on the received input. In this embodiment, optimization program 110 trains the at least one generated data model by analyzing the received input data and generating an estimated data model for each set of received input data (e.g., the estimation UQ measure). In this embodiment optimization program 110 generates an estimated model by training independent neural networks with the same input data (e.g., training data) but different random batches on each training step. Optimization program 110 trains each of the neural networks are trained to output a prediction and an error estimate for every set of parameters. Specifically, optimization program 110 can, in some embodiments, perform a brute force offline Maxwell solve) using Equation 3.

In step 206, optimization program 110 computes a parameter variable associated with the trained data model. A parameter variable as used herein can refer to a final prediction and associated error estimate and can be a fluctuating value having a predetermined range based on a type of parameter. For example, the parameter variable may be a minimum value of a range and could also refer to a maximum value within the range. In this embodiment, optimization program 110 computes an evaluation estimate value (e.g., sometimes referred to as the final prediction) and its associated error estimate using Equations 4 and 5 reproduced below:

$$\tilde{t} ( p ) = {μ}_{*} ( p ) = \frac{1}{J} {\sum }_{i = 1}^{J} {μ}_{i} ( p ) \qquad 4 )$$

$${}^{\sim} r ( p ) = {σ}_{*}^{2} ( p ) = \frac{1}{J} {\sum }_{i = 1}^{J} ( {σ}_{i}^{2} ( p ) + ( {μ}_{i}^{2} ( p ) - {μ}_{*}^{2} ( p ) - {μ}_{*}^{2} ( p ) ) ) \qquad 5 )$$

In equation 5, optimization program 110 defines r(p) as an uncertainty quantification measurement at the calculated parameter variable, which estimates a true error of the generated data model t(p) as an estimated solution value using a partial differential equation algorithm. In this equation, optimization program 110 defines σ* as an uncertainty measurement for the estimate value and μᵢ as an output value of the estimated data model.

In equation 4, J refers to the number of data points with the generated data model. In another embodiment, optimization program 110 defines J as the number of independent neural networks associated with the generated data model. In this embodiment, the evaluation estimate value is the calculated uncertainty quantification, which estimates a true error of the generated data model. These may be used as input of subsequent calculations and as an output of an estimated data model.

In another embodiment, optimization program 110 computes parameter variable associated with the trained data model by retrieving additional information associated with the trained data model; and estimating a predicted error value associated with the trained data model by evaluating at least two selected data points based on an evaluation estimate value using the partial differential equation algorithm associated with the retrieved additional information, wherein the evaluation estimate value estimates a predicted error value associated with the trained data model; and removing at least one evaluated, data point based on the estimated predicted error value associated with the trained data model.

In step 208, optimization program 110 dynamically selects at least one data point within the generated data model. In this embodiment, optimization program 110 dynamically selects at least one data point to further explore. In this embodiment, optimization program 110 dynamically selects a data point with a calculated parameter variable that has the highest uncertainty.

In this embodiment, optimization program 110 dynamically selects the data point by identifying the data points in a plurality of sampled points with the highest calculated uncertainty measurement. Optimization program 110 can then optimize the evaluation of the generated data model by reducing a number of selected data points within the generated data model based on the calculated parameter variable for each selected of the K points with highest uncertainty.

In step 210, optimization program 110 performs a query based on the selected data point. In this embodiment, optimization program 110 performs the query on the selected data points by retrieving additional information associated with the generated data model and evaluating the selected data points using the partial differential equation algorithm. In this embodiment, optimization program 110 evaluates the calculated parameter variable associated with the dynamically selected data points with the highest uncertainty expression using the following expression:

σ*²(p) 7)

In this embodiment, optimization program 110 further optimizes the evaluation of the generated data model by reducing the number of data points from the number of selected data points, which increases the efficiency of the evaluation of the generated data model.

In step 212, optimization program 110 automatically stores the dynamically selected data. In this embodiment, optimization program 110 can store the dynamically selected data in database 112. In another embodiment, optimization program 110 automatically retrains the data model based on the stored selected data points. In some embodiments, optimization program 110 performs steps 202-210 iteratively until a threshold level of data points (e.g., training data) is met.

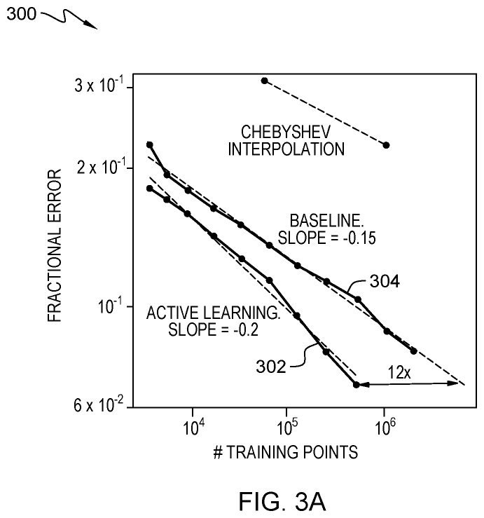

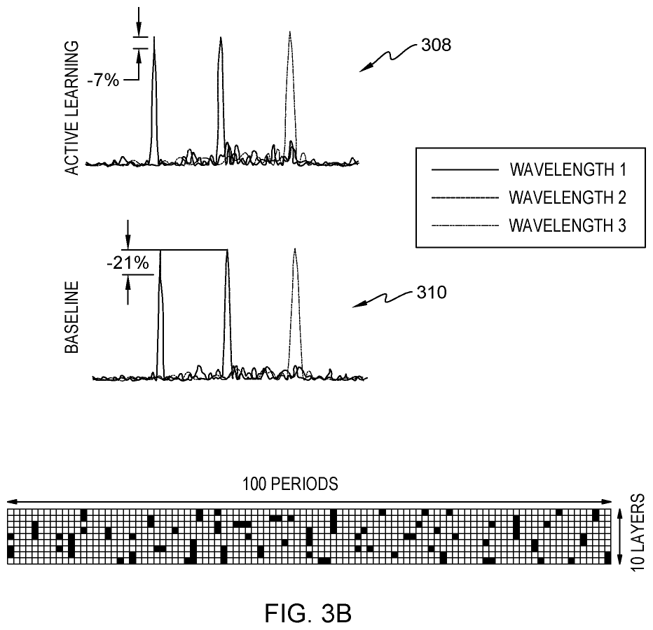

FIGS. 3A and 3B are a set of exemplary graphs displaying a plurality of results associated with dynamically selecting at least one data point within the generated data model, in accordance with at least one embodiment of the present invention.

Specifically, graph 300 illustrates that the lower the desired fractional error, the greater the reduction in training cost compared to the baseline algorithm; the slope of the active-learning fractional error (−0:2) is about 30% steeper than that of baseline (−0:15). The active-learning algorithm achieves a reasonable fractional error of 0:07 in twelve times less points than the baseline, which corresponds to more than one order of magnitude saving in training data. Chebyshev interpolation (surrogate for blue frequency only) does not compete well with this number of training points. Unit cell corresponding to the surrogate model.

FIG. 3A depicts graph 300 which shows a reduction of the number of training data points results in a lower fractional error associated with the optimized (e.g., generated) data model, graph 302. In graph 300, a baseline generated data model, graph 304, has 10⁶ number of data points with a fractional error of 2×10⁻¹ resulting in a slope of −0.15. In graph 300, optimization program 110 optimizes generated data model using the active learning algorithm that utilizes 10⁵ number of data points with a fractional error of 1.8×10⁻¹ resulting in a slope of −0.2. Graph 300 thus demonstrates that optimization program 110 obtains the same level of accuracy of roughly 7×10⁻² using 12× less training data compared to the baseline, which increases the efficiency of the evaluation of the generated data model by the same amount.

FIG. 3B depicts graphs 308 and 310 which shows a comparison between a baseline graph (e.g., graph 310) and the active learning graph (e.g., graph 308).

For example, the graphs illustrate an application to metalens design. Specifically, optimization program 110 used both surrogates models to design a multiplexer—an optical device that focuses different wavelength at different points in space. The actively learned surrogate model results in a design that much more closely matches a numerical validation than the baseline surrogate. In this example optimization program 110 replaces a Maxwell's equations solver with a surrogate model to rapidly compute the optical transmission through each unit cell; a similar surrogate approached could be used for optimizing many other complex physical systems. In the case of our two-dimensional unit cell, the surrogate model is two orders of magnitude faster than solving Maxwell's equations with a finite difference frequency domain (FDFD) solver. The speed advantage of a surrogate model becomes drastically greater in three dimensions, where PDE solvers are much more costly while a surrogate model remains the same.

Specifically, in this example, optimization program 110 used the active-learning and the baseline surrogates models to design a multiplexer—an optical device that focuses different wavelength at different points in space. The actively learned surrogate model results in a design that much more closely matches a numerical validation than the baseline surrogate. This shows that the active-learning surrogate is better at driving the optimization away from regions of inaccuracy. (graph 310) The resulting metastructure for the active-learning surrogate with 100 unit cells of 10 independent parameters each (one parameter per layer).

In graph 310 shows one order of magnitude higher number of data points while the active learning generated data model (e.g., graph 308 depicting the active learning generated data model) is 14%, results in the active learning data model, graph 308, being 14% more accurate. Therefore, optimization program 110 degrades the performance of the computing device 102 by 7% for the active learned data model, graph 308, and by 21% for the computing device 102 with the baseline data model 306 via dynamically selecting data points using calculated parameter variables, which results in a 14% increase in efficiency in evaluating the generated data model. In graph 304, an average generated data model, graph 310 is depicted as a calculated difference between the baseline generated data model 306 and the active learning generated data model, graph 308.

### Further Comments and/or Embodiments

Embodiments of the present invention recognize certain benefits and improvements to the current state of art: i) embodiments of the present invention can apply machine learning techniques to inverse design problems, that is, find optimal parameters with many surrogates), ii) apply machine learning techniques to large scale optimization for PDEs, that is, combine and couple multiple surrogate models in a large scale framework), iii) can provide a critical component in a general framework for inverse design, particularly with problems where decomposition methods apply, iv) can amortize learning cost and hence be more effective than random sampling one order of magnitude less data is needed, v) can provide a surrogate model that is at least two order of magnitude faster than solving the PDE directly, and vi) the active learning algorithm is shown to work with an uncertainty estimate based on an ensemble of heteroscedastic gaussian models but can generalize to any type of uncertainty measure.

Embodiments of the present invention recognize certain deficiencies in the current state of the art: i) active learning for surrogate training has not yet been explored before, ii) usual active learning methods such as adding previous large scale simulation optima to the training set, fail where the active learning approach disclosed herein performs well, and iii) in contrast to gaussian processes, which do not scale very well with the number of training points, embodiments of the present invention can easily use a lot of training points for complex problems while ensuring that more training are not generated than needed.

Surrogate models for partial-differential equations are widely used in the design of metamaterials to rapidly evaluate the behavior of composable components. However, the training cost of accurate surrogates by machine learning can rapidly increase with the number of variables. For photonic-device models, we find that this training becomes especially challenging as design regions grow larger than the optical wavelength. We present an active learning algorithm that reduces the number of training points by more than an order of magnitude for a neural-network surrogate model of optical-surface components compared to random samples. Results show that the surrogate evaluation is over two orders of magnitude faster than a direct solve, and we demonstrate how this can be exploited to accelerate large-scale engineering optimization.

### Introduction

Designing metamaterials or composite materials, in which computational tools select composable components to recreate desired properties that are not present in the constituent materials, is a crucial task for a variety of areas of engineering (acoustic, mechanics, thermal/electronic transport, electromagnetism, and optics). For example, in metalenses, the components are subwavelength scatterers on a surface, but the device diameter is often >10³ wavelengths. For example there can be a three-dimensional unit cell displayed as a two parameter, H-shape unit cell with four parameters. The two-dimension unit cell displayed as a multi-layer unit cell with holes with ten parameters. The transmitted field of the unit-cell is computed with periodic boundary conditions. When the period is subwavelength, the transmitted field can be summarized by a single complex number—the complex transmission. Unit cells (with independent sets of parameters) are juxtaposed to form a metasurface which is optimized to scatter light in a prescribed way. Using the local periodic approximation and the unit cell simulations, some embodiments of the present invention can efficiently compute the approximate source equivalent to the metasurface and generate the field anywhere in the far-field. As the metamaterials become larger in scale and as the manufacturing capabilities improve, there is a pressing need for scalable computational design tools.

Some embodiments of the present invention determine that surrogate models were used to rapidly evaluate the effect of each metamaterial components during device design, and machine learning is an attractive technique for such models. However, in order to exploit improvements in nano-manufacturing capabilities, components have an increasing number of design parameters and training the surrogate models (using brute-force numerical simulations) becomes increasingly expensive. Some embodiments of the present invention present a new active-learning (“AL”) approach—in which training points are selected based on an error measure that can reduce the number of training points by more than an order of magnitude for a neural-network (“NN”) surrogate model of partial-differential equations (“PDEs”). Further, some embodiments of the present invention show how such a surrogate can be exploited to speed up large-scale engineering optimization by >100×. In particular, some embodiments of the present invention apply the approach to the design of optical metasurface: large (10²-10⁶ wavelengths λ) aperiodic nanopatterned (<<λ) structures that perform functions such as compact lensing.

Metasurface design can be performed by breaking the surface into unit cells with a few parameters each in FIG. 3A via domain-decomposition approximations, learning a “surrogate” model that predicts the transmitted optical field through each unit as a function of an individual cell's parameters, and optimizing the total field (e.g., the focal intensity) as a function of the parameters of every unit cell. This makes metasurfaces an attractive application for machine learning because the surrogate unit-cell model is re-used millions of times during the design process, amortizing the cost of training the model based on expensive “exact” Maxwell solves sampling many unit-cell parameters. For modeling the effect of a 1-4 unit-cell parameters, Chebyshev polynomial interpolation can be very effective, but encounters an exponential “curse of dimensionality” with more parameters. Some embodiments of the present invention find that a NN can be trained with orders of magnitude fewer Maxwell solves for the same accuracy with ˜10 parameters, even for the most challenging case of multi-layer unit cells many wavelengths (>10λ) thick. In contrast, some embodiments of the present invention show that subwavelength-diameter design regions require orders of magnitude fewer training points for the same number of parameters, corresponding to the physical intuition that wave propagation through subwavelength regions is effectively determined by a few “homogenized” parameters, making the problems effectively low-dimensional. In contrast to typical machine-learning applications, constructing surrogate models for physical model such as Maxwell's equations corresponds to interpolating smooth functions with no noise, and this requires new approaches to training and active learning. Some embodiments of the present invention greatly extend the reach of surrogate model for metamaterial optimization and other applications requiring moderate-accuracy high-dimensional smooth interpolation.

Recent work has demonstrated a wide variety of optical-metasurface design problems and algorithms. Different applications such as holograms, polarization, wavelength, depth-of-field, or incident angle-dependent functionality are useful for imaging or spectroscopy. Some embodiments of the present invention introduce an optimization approach to metasurface design using Chebyshev-polynomial surrogate model, which was subsequently extended to topology optimization (˜10³ parameters per cell) with “online” Maxwell solvers. Metasurface modeling can also be composed with signal/image-processing stages for optimized “end-to-end design.” Previous work demonstrated NN surrogate models in optics for a few parameters, or with more parameters in deeply subwavelength design regions. Some embodiments of the present invention determine that subwavelength regions pose a vastly easier problem for NN training than parameters spread over larger diameters. Another approach involves generative design, again typically for subwavelength or wavelength-scale unit cells, in some cases in conjunction with larger-scale models. A generative model is essentially the inverse of a surrogate function: instead of going from geometric parameters to performance, it takes the desired performance as an input and produces the geometric structure, but the mathematical challenge appears to be closely related to that of surrogates.

Active learning (“AL”) is connected with the field of uncertainty quantification (“UQ”), because AL consists of adding the “most uncertain” points to training set in an iterative way and hence it requires a measure of uncertainty. Some embodiments of the present invention approach to UQ is based on the NN-ensemble idea due to its scalability and reliability. There are many other approaches for UQ, but demonstrated performance and scalability advantages of the NN-ensemble approach. In contrast, Bayesian optimization relies on Gaussian processes that scale poorly (˜N³ where N is the number of training samples). Some embodiments of the present invention are the first to achieve training time efficiency (some embodiments of the of the present invention show an order of magnitude reduction sample complexity), design time efficiency (the actively learned surrogate model is at least two orders of magnitude faster than solving Maxwell's equations), and realistic large-scale designs (due to the optimization framework), all in one package.

### Metasurfaces and Surrogate Models

Some embodiments of the present invention present the neural-network surrogate model that adopts the metasurface design formulation. The first step of this approach is to divide the metasurface into unit cells with a few geometric parameters p each. For example, some embodiments of the present invention show several possible unit cells: (a) a rectangular pillar (“fin”) etched into a 3d dielectric slab (two parameters); (b) an H-shaped hole (four parameters) in a dielectric slab; or a (c) multilayered 2d unit cell with ten holes of varying widths. Some embodiments of the present invention depict a metasurface consists of an array of these unit cells. The second step is to solve for the transmitted field (from an incident planewave) independently for each unit cell using approximate boundary conditions, a locally periodic approximation (LPA) based on the observation that optimal structures often have parameters that mostly vary slowly from one unit cell to the next. For a subwavelength period, the LPA transmitted far field is entirely described by a single number—the complex transmission coefficient t(p). One can then compute the field anywhere above the metasurface by convolving these approximate transmitted fields with a known Green's function, a near-to-farfield transformation. Finally, any desired function of the transmitted field, such as the focal-point intensity, can be optimized as a function of the geometric parameters of each unit cell.

In this way, optimizing an optical metasurface is built on top of evaluating the function t(p) (transmission through a single unit cell as a function of its geometric parameters) thousands or even millions of times—once for every unit cell, for every step of the optimization process. Although it is possible to solve Maxwell's equations “online” during the optimization process, allowing one to use thousands of parameters p per unit cell requires substantial parallel computing clusters. Alternatively, one can solve Maxwell's equations “offline” (before metasurface optimization) in order to fit t(p) to a surrogate model

\tilde{t}(p)≈t(p) 8)

With respect to equation 8, some embodiments of the present invention can subsequently be evaluated rapidly during metasurface optimization (perhaps for many different devices). For similar reasons, surrogate (or “reduced-order”) models are attractive for any design problem involving a composite of many components that can be modeled separately. The key challenge of the surrogate approach is to increase the number of design parameters, especially in non-subwavelength regions.

The surrogate model for each of the real and imaginary parts of the complex transmission is an ensemble of J=5 independent neural networks (NNs) with the same training data but different random “batches” on each training step. Each of NN i is trained to output a prediction μᵢ (p) and an error estimate σᵢ (p) for every set of parameters p. To obtain these μᵢ and σᵢ from training data y(p) (from brute-force “offline” Maxwell solves) minimize:

$$- {\sum }_{p} log {p}_{{Θ}_{i}} ( y \vert p ) = {\sum }_{p} [ log {σ}_{i} ( p ) + \frac{{( y ( p ) - {μ}_{i} ( p ) )}^{2}}{2 {{σ}_{i} ( p )}^{2}} ] \qquad 9 )$$

With respect to equation 9, some embodiments of the present invention minimize over the parameters Θᵢ of NN i. Equation 4 is motivated by problems in which y was sampled from a Gaussian distribution for each p, in which case μᵢ and σᵢ² could be interpreted as mean and hetero-skedastic variance, respectively. Although some embodiments of the present invention function t(p) are smooth and noise-free, equation 4 still works well to estimate the fitting error. Each NN is composed of an input layer with 13 nodes (10 nodes for the geometry parameterization and 3 nodes for the one-hot encoding of three frequencies of interest), three fully-connected hidden layers with 256 rectified linear units, and one last layer containing one unit with a scaled hyperbolic-tangent activation function (for μᵢ) and one unit with a softplus activation function (for σᵢ). Given this ensemble of J NNs, the final prediction μ* (for the real or imaginary part of t(p)) and its associated error estimate σ* are amalgamated as:

$${μ}_{*} ( p ) = \frac{1}{J} {\sum }_{i = 1}^{J} {μ}_{i} ( p ) \qquad 10 )$$

$${σ}_{*}^{2} ( p ) = \frac{1}{J} {\sum }_{i = 1}^{J} ( {σ}_{i}^{2} ( p ) + {μ}_{i}^{2} ( p ) ) - {μ}_{*}^{2} ( p ) . \qquad 11 )$$

### Subwavelength is Easier: Effect of Diameter

Before performing active learning, some embodiments of the present invention first identify the regime where active learning can be most useful: unit-cell design volumes that are not small compared to the wavelength k. Previous work on surrogate models demonstrated NN surrogates (trained with random samples) for unit cells with ˜10² parameters. However, these NN models were limited to a regime where the unit cell degrees of freedom lay within a subwavelength-diameter volume of the unit cell. To illustrate the effect of shrinking design volume on NN training, some embodiments of the present invention train surrogate model for three unit cells. Some embodiments of the present invention depict a main unit cell of this study is 12.5λ deep, the small unit cell is a vertically scaled-down version of the normal unit cell only 1.5λ deep, and the smallest unit cell is a version of the small unit cell further scaled down (both vertically and horizontally) by 10×. Some embodiments of the present invention show that, for the same number of training points, the fractional error on the test set of the small unit cell and the smallest unit cell are, respectively, one and two orders of magnitude better than the error of the main unit cell when using 1000 training points or more.

For the same number of training points, the fractional error (defined in Methods) on the test set of the small unit cell and the smallest unit cell are, respectively, one and two orders of magnitude better than the error of the main unit cell when using 1000 training points or more, which indicates that parameters are more independent when the design-region diameter is big (>>λ), and training the surrogate model becomes harder.

Physically, for extremely sub-wavelength volumes the waves only “see” an averaged effective medium, so there are effectively only a few independent design parameters regardless of the number of geometric degrees of freedom. Quantitatively, some embodiments of the present invention find that the Hessian of the trained surrogate model (second-derivative matrix) in the smallest unit-cell case is dominated by only two singular values—consistent with a function that effectively has only two free parameters—with the other singular values being more than 100× smaller in magnitude; for the other two cases, many more training points would be required to accurately resolve the smallest Hessian singular values. A unit cell with large design-volume diameter (>>λ) is much harder to train, because the dimensionality of the design parameters is effectively much larger.

### Active-Learning Algorithm

Here, some embodiments of the present invention present an algorithm to choose training points that is significantly better at reducing the error than choosing points at random. As described below, some embodiments of the present invention select the training points where the estimated model error is largest, given the estimated error σ*.

Initially some embodiments of the present invention choose nᵢₙᵢₜ uniformly distributed random points p₁, p₂, . . . , pₙ_{ᵢₙᵢₜ} to train a first iteration \hat{t}⁰(p) over 50 epochs. Then, given the model at iteration i, some embodiments of the present invention evaluate \tilde{t}ⁱ(p) (which is orders of magnitude faster than the Maxwell solver) at MK points sampled uniformly at random and choose the K points that correspond to the largest σ*². Some embodiments of the present invention perform the expensive Maxwell solves only for these K points, and add the newly labeled data to the training set. Some embodiments of the present invention train \tilde{t}ⁱ⁺¹(p) with the newly augmented training set. Some embodiments of the present invention repeat this process T times.

Some embodiments of the present invention compared the fractional errors of a NN surrogate model trained using uniform random samples with an identical NN trained using an active learning approach, in both cases modeling the complex transmission of a multi-layer unit cell with ten independent parameters. The baseline corresponds to T=0, and nᵢₙᵢₜ equal to the total number of training points. This corresponds to no active learning at all, because the ninit points are chosen at random. In the case of active learning, nᵢₙᵢₜ=2000, M=4, and we computed for K=500, 1000, 2000, 4000, 8000, 16000, 32000, 64000, and 128000. Although three orders of magnitude on the log-log plot is too small to determine if the apparent linearity indicates a power law, some embodiments of the present invention show that the lower the desired fractional error, the greater the reduction in training cost compared to the baseline algorithm; the slope of the active-learning fractional error (−0.2) is about 30% steeper than that of baseline (−0.15). The active-learning algorithm achieves a reasonable fractional error of 0.07 in twelve times less points than the baseline, which corresponds to more than one order of magnitude saving in training data (much less expensive Maxwell solves). This advantage would presumably increase for a lower error tolerance, though computational costs prohibited us from collecting orders of magnitude more training data to explore this in detail. For comparison and completeness, some embodiments of the present invention show fractional errors using Chebyshev interpolation (for the blue frequency only). Chebyshev interpolation has a much worse fractional error for a similar number of training points. Chebyshev interpolation suffers from the “curse of dimensionality”—the number of training points is exponential with the number of variables. The two fractional errors shown are for three and four interpolation points in each of the dimensions, respectively. In contrast, NNs are known to mitigate the “curse of dimensionality”.

Some embodiments of the present invention use both surrogates' models to design a multiplexer—an optical device that focuses different wavelength at different points in space. The actively learned surrogate model results in a design that much more closely matches a numerical validation than the baseline surrogate. Some embodiments of the present invention replace a Maxwell's equations solver with a surrogate model to rapidly compute the optical transmission through each unit cell; a similar surrogate approached could be used for optimizing many other complex physical systems. In the case of our two-dimensional unit cell, the surrogate model is two orders of magnitude faster than solving Maxwell's equations with a finite difference frequency domain (“FDFD”) solver. The speed advantage of a surrogate model becomes drastically greater in three dimensions, where PDE solvers are much more costly while a surrogate model remains the same.

The surrogate model is evaluated millions of times during a meta-structure optimization. Some embodiments of the present invention use the actively learned surrogate model and the baseline surrogate model (random training samples), in both cases with 514000 training points, and optimized a ten-layer metastructure with 100 unit cells of period 400 nm for a multiplexer application—where three wavelengths (blue: 405 nm, green: 540 nm, and red: 810 nm) are focused on three different focal spots (−10 μm, 60 μm), (0, 60 μm), and (+10 μm, 60 μm), respectively. The diameter is 40 μm and the focal length is 60 μm, which corresponds to a numerical aperture of 0.3. The optimization scheme tends to yield results robust to manufacturing errors for two reasons: first, some embodiments of the present invention optimize for the worst case of the three focal spot intensities, using an epigraph formulation; second, some embodiments of the present invention compute the average intensity from an ensemble of surrogate models that can be thought of as a Gaussian distribution \tilde{t}(p)=μ*(p)ϵ+σ*(p)ϵ with ϵ˜N(0, 1), and μ* and σ* are defined in equation 5 and 6, respectively.

[symbol]

|E(r)|²=|∫Gμ*|²|∫Gσ*|² 12)

With respect to equation 12, G is a Green's function that generates the far-field from the sources of the metastructure.

In order to compare the surrogate models, some embodiments of the present invention validate the designs by computing the optimal unit cell fields directly using a Maxwell solver instead of using the surrogate model. This is computationally easy because it only needs to be done once for each of the 100 unit cells instead of millions of times during the optimization. The focal lines—the field intensity along a line parallel to the two-dimensional metastructure and passing through the focal spots—resulting from the validation are exact solutions to Maxwell's equations assuming the locally periodic approximation. Some embodiments of the present invention show the resulting focal lines for the active-learning and baseline surrogate models. A multiplexer application requires similar peak intensity for each of the focal spots, which is achieved using worst case optimization. Some embodiments of the present invention show that the actively learned surrogate has ≈3× smaller error in the focal intensity compared to the baseline surrogate model. This result shows that not only is the active-learning surrogate more accurate than the baseline surrogate for 514000 training points, but also the results are more robust using the active-learning surrogate—the optimization does not drive the parameters towards regions of high inaccuracy of the surrogate model. Note that we limited the design to a small overall diameter (100 unit cells) mainly to ease visualization, and some embodiments of the present invention find that this design can already yield good focusing performance despite the small diameter. Some embodiments of the present invention have already demonstrated that the optimization framework is scalable to designs that are orders of magnitudes larger.

Some embodiments of the present invention approach active-learning that does not quantify uncertainty—suggested iteratively adding the optimum design points to the training set (re-optimizing before each new set of training points is added). However, some embodiments of the present invention did not find this approach to be beneficial. In particular, some embodiments of the present invention tried adding the data generated from LPA validations of the optimal design parameters, in addition to the points selected by our active learning algorithm, at each training iteration, but some embodiments of the present invention found that this actually destabilized the learning and resulted in designs qualitatively worse than the baseline. By exploiting validation points, it seems that the active learning of the surrogate tends to explore less of the landscape of the complex transmission function, and hence leads to poorer designs. Such exploitation—exploration trade-offs are known in the active-learning literature.

### Concluding Remarks

Some embodiments of the present invention present an active-learning algorithm for composite materials which reduces the training time of the surrogate model for a physical response, by at least one order of magnitude. The simulation time is reduced by at least two orders of magnitude using the surrogate model compared to solving the partial differential equations numerically. While the domain-decomposition method used here is the locally periodic approximation and the partial differential equations are the Maxwell equations, the proposed approach is directly applicable to other domain-decomposition methods (e.g., overlapping domain approximation) and other partial differential equations or ordinary differential equations.

Some embodiments of the present invention use an ensemble of NNs for interpolation in a regime that is seldom considered in the machine-learning literature—when the data is obtained from a smooth function rather than noisy measurements. In this regime, it would be instructive to have a deeper understanding of the relationship between NNs and traditional approximation theory (e.g., with polynomials and rational functions). For example, the likelihood maximization of our method forces σ* to go to zero when \tilde{t}(p)=t(p). Although this allows us to simultaneously obtain a prediction μ* and an error estimate σ*, there is a drawback. In the interpolation regime (when the surrogate is fully determined), σ* would become identically zero even if the surrogate does not match the exact model away from the training points. In contrast, interpolation methods such as Chebyshev polynomials yield a meaningful measure of the interpolation error even for exact interpolation of the training data. In the future, some embodiments of the present invention plan to separate the estimation model and the model for the error measure using a meta-learner architecture, with expectation that the meta-learner will produce a more accurate error measure and further improve training time. Some embodiments of the present invention extend the reach of surrogate-model based optimization of composite materials and other applications requiring moderate-accuracy high-dimensional interpolation.

### Methods

The complex transmission coefficients were computed in parallel using an open-source finite difference frequency-domain solver for Helmholtz equation on a 3.5 GHz 6-Core Intel Xeon E5 processor. The material properties of the multi-layered unit cells are silica (refractive index of 1.45) in the substrate, and air (refractive index of 1) in the hole and in the background. In the normal unit cell, the period of the cell is 400 nm, the height of the ten holes is fixed to 304 nm and their widths varies between 60 nm and 340 nm, each hole is separated by 140 nm of substrate. In the small unit cell, the period of the cell is 400 nm, the height of the ten holes is 61 nm, and their widths varies between 60 nm and 340 nm, there is no separation between the holes. The smallest unit cell is the same as the small unit cell shrunk ten times (period of 40 nm, ten holes of height 6.1 nm and width varying between 6 nm and 34 nm).

The complex transmission data is used to compute the scattered field off a multi-layered metastructure with 100 unit cells. The metastructure was designed to focus three wavelengths (blue: 405 nm, green: 540 nm, and red: 810 nm) on three different focal spots (−10 μm, 60 μm), (0, 60 μm), and (+10 μm, 60 μm), respectively. The epigraph formulation of the worst case optimization and the derivation of the adjoint method to get the gradient. Any gradient based-optimization algorithm would work, but some embodiments of the present invention used an algorithm based on conservative convex separable approximations. The average intensity is derived from the distribution of the surrogate model \tilde{t}(p)=μ*(p)+σ*(p)ϵ with ϵ˜N(0, 1) and the computation of the intensity based on the local field is depicted as the following:

$${\vert E ( r ) \vert}^{2} = {\vert {\int }_{\sum } G ( r , {r}^{′} ) ( - \tilde{t} ( p ( \vec{r} ) ) {dr}^{′} \vert}^{2} , \\ = {\int }_{\sum } \overline{G} ( \overline{{μ}_{*}} ( p ) + {\overline{σ}}_{*} ( p ) ϵ ) {dr}^{′} {\int }_{\sum } G ( {μ}_{*} ( p ) + {σ}_{*} ( p ) ϵ ) {dr}^{′} , \\ = \int \overline{G} {\overline{μ}}_{*} \int G {μ}_{*} + {ϵ}^{2} \int \overline{G} {\overline{σ}}_{*} \int G {σ}_{*} + R ϵ R e ( \int \overline{G} {\overline{μ}}_{*} \int G {σ}_{*} ) , \\ = {\vert \int G {μ}_{*} \vert}^{2} + {ϵ}^{2} {\vert \int G {σ}_{*} \vert}^{2} + 2 ϵ R e ( \int \overline{G} {\overline{μ}}_{*} \int G {σ}_{*} ) , \qquad 13 )$$

Where the (⋅̅) notation denotes the complex conjugate, the notations ∫_{Σ}(⋅) dr′ and G (r, r′) are simplified to p, ∫ and G, and the notation p (̅r̅)̅ is dropped for clarity. From the linearity of expectation:

[symbol]

|E(r)|²=|∫Gμ*|²+ [symbol] (ϵ²)|∫Gσ*|²+2 [symbol] (ϵ)Re(∫G̅μ̅*∫Gσ*), 17)

[symbol]

|E(r)|²=|∫Gμ*|²+|∫Gσ*|², 16)

With respect to equation 13 and equation 14, some embodiments of the present invention define [symbol] (ϵ)=0 and [symbol] (ϵ²)=1.

The ensemble of NN was implemented using PyTorch 51 on a 3.5 GHz 6-Core Intel Xeon E5 processor. Some embodiments of the present invention train an ensemble of 5 NN for each surrogate models. Each NN is composed of an input layer with 13 nodes (10 nodes for the geometry parameterization and 3 nodes for the one-hot encoding of three frequencies of interest), three fully-connected hidden layers with 256 rectified linear units (ReLU), and one last layer containing one unit with a scaled hyperbolic-tangent activation function (for μi) and one unit with a soft plus activation function (for σi). The cost function is a Gaussian loglikelihood as in equation 4). The mean and the variance of the ensemble are the pooled mean and variance from equation 5) and equation 6). The optimizer is Adam. The starting learning rate is 0.001. After the tenth epoch, the learning rate is decayed by a factor of 0.99. Each iteration of the active learning algorithm as well as the baseline were trained for 50 epochs. The quantitative evaluations were computed using the fractional error on a test set containing 2000 points chosen at random. The fractional error F E between two vectors of complex values \vec{u}ₑₛₜᵢₘₐₜₑ and \vec{v}ₜᵣᵤₑ si

$$FE = \frac{\vert {\vec{u}}_{estimate} - {\vec{v}}_{true} \vert}{\vert {\vec{v}}_{true} \vert} \qquad 15 )$$

With respect to equation 15, some embodiments of the present invention define |⋅| is the L2-norm for complex vectors.

FIG. 4 depicts a block diagram of components of computing systems within computing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 400 includes communications fabric 402, which provides communications between cache 416, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Optimization program 110 (not shown) may be stored in persistent storage 408 and in memory 406 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links. Optimization program 110 may be downloaded to persistent storage 508 through communications unit 412.

I/O interface(s) 414 allows for input and output of data with other devices that may be connected to client computing device and/or server computer. For example, I/O interface 414 may provide a connection to external devices 420 such as a keyboard, keypad, a touch screen, and/or some other suitable input device. External devices 420 can also include portable computer readable storage media such as, for example, thumb drives, portable optical or magnetic disks, and memory cards. Software and data used to practice embodiments of the present invention, e.g., optimization program 110, can be stored on such portable computer readable storage media and can be loaded onto persistent storage 408 via I/O interface(s) 414. I/O interface(s) 414 also connect to a display 422.

Display 422 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
in response to receiving parameters associated with a problem, training at least one generated data model to evaluate an estimation of a solution for the problem;
generating an uncertainty quantification measure associated with an estimation of error for the at least one generated data model;
filtering data based on the generated uncertainty quantification measure associated with the at least one generated data model; and
automatically retraining the at least one generated data model using remaining data from the filtered data.

2. The computer-implemented method of claim 1, wherein in response to receiving parameters associated with a problem, training at least one generated data model to evaluate an estimation of a solution for the problem comprises:
generating an estimated data model for each set of received parameters associated with the problem.

3. The computer-implemented method of claim 1, wherein generating an uncertainty quantification measure associated with an estimation of error for the at least one generated data model comprises:
estimating a predicted error value associated with the trained data model by evaluating at least two selected data points based on an evaluation estimate value using a partial differential equation algorithm, wherein the evaluation estimate value estimates a predicted error value associated with the trained data model; and
removing at least one evaluated data point based on the estimated predicted error value associated with the trained data model.

4. The computer-implemented method of claim 1, wherein filtering data comprises:
dynamically selecting at least one data point within the trained data model based on a computed parameter variable, wherein the computed parameter variable estimates a true error of the trained data model as an estimated solution value using a partial differential equation algorithm.

5. The computer-implemented method of claim 4, wherein dynamically selecting the at least one data point comprises:
identifying the at least one data point in a plurality of sampled points with the uncertainty quantification measure; and
reducing a number of selected data points within the at least one generated data model based the uncertainty quantification measure.

6. The computer-implemented method of claim 1, further comprising:
performing the query based on the remaining data wherein performing a query based on remaining data from the filtered data using a partial differential equation algorithm.

7. The computer-implemented method of claim 6, further comprising:
verifying the remaining data points using the partial differential equation algorithm; and
selecting remaining data points having a highest uncertainty.

8. A computer program product comprising:
one or more computer readable storage media and program instructions stored on the one or more computer readable storage media, the program instructions comprising:
program instructions to, in response to receiving parameters associated with a problem, train at least one generated data model to evaluate an estimation of a solution for the problem;
program instructions to generate an uncertainty quantification measure associated with an estimation of error for the at least one generated data model;
program instructions to filter data based on the generated uncertainty quantification measure associated with the at least one generated data model; and
program instructions to automatically retrain the at least one generated data model using remaining data from the filtered data.

9. The computer program product of claim 8, wherein the program instructions to, in response to receiving parameters associated with a problem, train at least one generated data model to evaluate an estimation of a solution for the problem comprise:
program instructions to generate an estimated data model for each set of received parameters associated with the problem.

10. The computer program product of claim 8, wherein the program instructions to generate an uncertainty quantification measure associated with an estimation of error for the at least one generated data model comprise:
program instructions to estimate a predicted error value associated with the trained data model by evaluating at least two selected data points based on an evaluation estimate value using a partial differential equation algorithm, wherein the evaluation estimate value estimates a predicted error value associated with the trained data model; and
program instructions to remove at least one evaluated data point based on the estimated predicted error value associated with the trained data model.

11. The computer program product of claim 8, wherein the program instructions to filter data comprises:
program instructions to dynamically select at least one data point within the trained data model based on a computed parameter variable, wherein the computed parameter variable estimates a true error of the trained data model as an estimated solution value using a partial differential equation algorithm.

12. The computer program product of claim 11, wherein the program instructions to dynamically select the at least one data point comprise:
program instructions to identify the at least one data point in a plurality of sampled points with the uncertainty quantification measure; and
program instructions to reduce a number of selected data points within the at least one generated data model based the uncertainty quantification measure.

13. The computer program product of claim 8, wherein the program instructions stored on the one or more computer readable storage media further comprise:
program instructions to perform the query based on the remaining data wherein performing a query based on remaining data from the filtered data using a partial differential equation algorithm.

14. The computer program product of claim 13, wherein the program instructions stored on the one or more computer readable storage media further comprise:
program instructions to verify the remaining data points using the partial differential equation algorithm; and
program instructions to select remaining data points having a highest uncertainty.

15. A computer system comprising:
one or more computer processors;
one or more computer readable storage media; and
program instructions stored on the one or more computer readable storage media for execution by at least one of the one or more computer processors, the program instructions comprising:
program instructions to, in response to receiving parameters associated with a problem, train at least one generated data model to evaluate an estimation of a solution for the problem;
program instructions to generate an uncertainty quantification measure associated with an estimation of error for the at least one generated data model;
program instructions to filter data based on the generated uncertainty quantification measure associated with the at least one generated data model; and
program instructions to automatically retrain the at least one generated data model using remaining data from the filtered data.

16. The computer system of claim 15, wherein the program instructions to, in response to receiving parameters associated with a problem, train at least one generated data model to evaluate an estimation of a solution for the problem comprise:
program instructions to generate an estimated data model for each set of received parameters associated with the problem.

17. The computer system of claim 15, wherein the program instructions to generate an uncertainty quantification measure associated with an estimation of error for the at least one generated data model comprise:
program instructions to estimate a predicted error value associated with the trained data model by evaluating at least two selected data points based on an evaluation estimate value using a partial differential equation algorithm, wherein the evaluation estimate value estimates a predicted error value associated with the trained data model; and
program instructions to remove at least one evaluated data point based on the estimated predicted error value associated with the trained data model.

18. The computer system of claim 15, wherein the program instructions to filter data comprises:
program instructions to dynamically select at least one data point within the trained data model based on a computed parameter variable, wherein the computed parameter variable estimates a true error of the trained data model as an estimated solution value using a partial differential equation algorithm.

19. The computer system of claim 18, wherein the program instructions to dynamically select the at least one data point comprise:
program instructions to identify the at least one data point in a plurality of sampled points with the uncertainty quantification measure; and
program instructions to reduce a number of selected data points within the at least one generated data model based the uncertainty quantification measure.

20. The computer system of claim 15, wherein the program instructions stored on the one or more computer readable storage media further comprise:
program instructions to perform the query based on the remaining data wherein performing a query based on remaining data from the filtered data using a partial differential equation algorithm.
